(19) United States
(12) Patent Application Publication
(10) Pub. No.: US 2005/0094390 A1
(43) Pub. Date: May 5, 2005

(54) Lamp assembly for billboard

(76) Inventor: Wan-Pao Chou, Miaoli County (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 10/700,492

(22) Filed: Nov. 5, 2003

(51) Int. Cl. F21S 2/00

(52) U.S. Cl. 362/227

(57) ABSTRACT

A lamp assembly mountable on a billboard is disclosed. The assembly includes a plurality of units each comprising a seat having a section of U, the seat including two lengthwise grooves at both sides, the seat being threadedly secured to the billboard; and a parallelepiped positioning member including two side flanges snugly fitted in the grooves for coupling the positioning member and the seat together, two front blades, two rear slits, and a lamp threaded coupled thereon. The blades and the slits of one unit are electrically coupled together. The lamp is electrically coupled to both the blades and the slits. The blades of one unit are adapted to insert into the slits of a second unit. The slits of one unit are adapted to receive the blades of a third unit. Other shapes of unit are also possible.

### BACKGROUND OF THE INVENTION

1. Field of the Invention

The present invention relates to lamp arrangements and more particularly to a lamp assembly having a plurality of lamps adapted to arrange in one of different shapes for easily mounting on a billboard or detaching therefrom.

2. Description of Related Art

As understood that billboards are one of the most effective means for attracting people. Hence, it is typical to mount lamps in the billboard for lighting in the night. Therefore, many lamp arrangements have been proposed for achieving that purpose. However, the prior lamp arrangements, as observed by the present inventor, have one or more of the following drawbacks such as being unreliable, difficult of mounting or disassembly, and even unsafe. Thus, the need for improvement still exists.

### SUMMARY OF THE INVENTION

It is an object of the present invention to provide a lamp assembly mountable on a billboard, the lamp assembly including a plurality of units each comprising an elongated seat having a section of U, the seat including a lengthwise slot and two lengthwise grooves at both side walls wherein the seat is threadedly secured to the billboard; and a substantially parallelepiped positioning member including two lengthwise side flanges snugly fitted in the grooves for coupling the positioning member and the seat together, two blades at a forward side, two slits at a rear side, and a lamp threaded coupled thereon, wherein the blades and the slits of one unit are electrically coupled together, the lamp is electrically coupled to both the blades and the slits, the blades of one unit are adapted to insert into the slits of a second adjacent unit, and the slits of one unit are adapted to receive the blades of a third adjacent unit.

In one aspect of the present invention two units are formed as a unit member having a shape of L.

In another aspect of the present invention two units are formed as a bent unit member with one unit being disposed about 45 degrees with respect to the other unit.

The above and other objects, features and advantages of the present invention will become apparent from the following detailed description taken with the accompanying drawings.

### BRIEF DESCRIPTION OF THE DRAWINGS

FIG. 1 is a perspective view of a portion of billboard having a lamp assembly according to the invention mounted thereon;

FIG. 2 is an exploded view of a unit of the lamp assembly;

FIG. 3 is a perspective view of the positioning member with the cover removed for showing interior details; and

FIGS. 4 and 5 are perspective views each showing a different configuration of the unit of the lamp assembly.

### DETAILED DESCRIPTION OF THE PREFERRED EMBODIMENTS

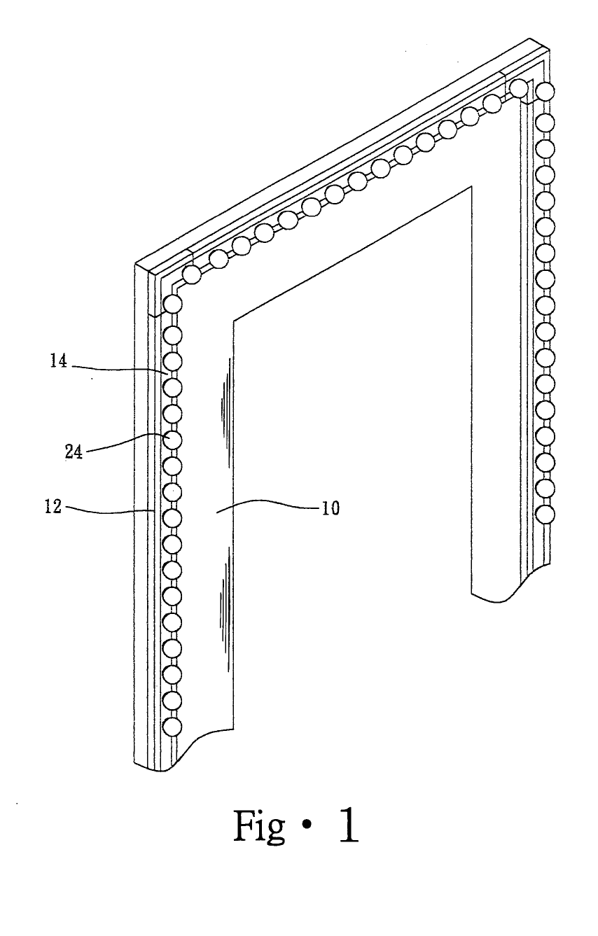

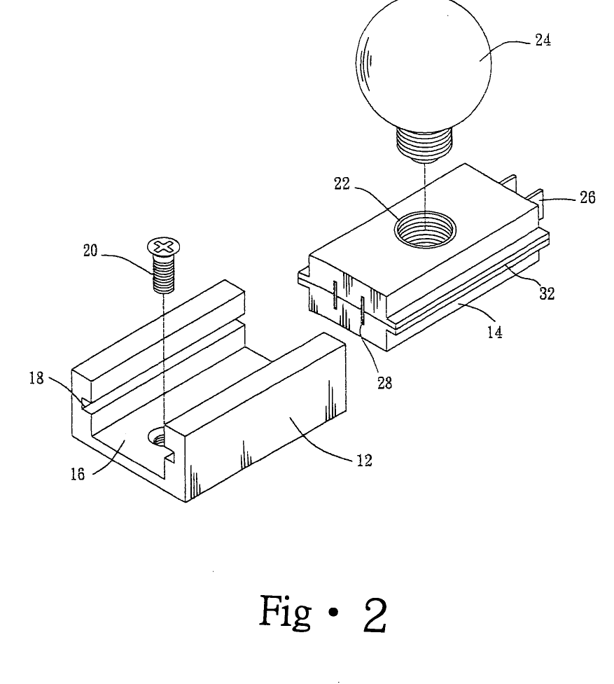

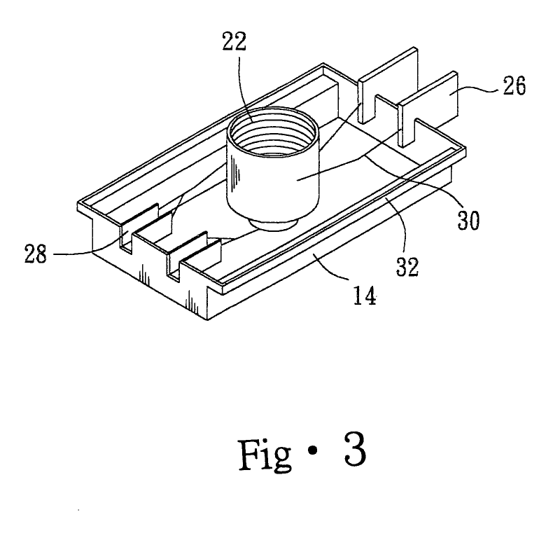

Referring to FIGS. 1, 2, and 3, a lamp assembly adapted to mount on a billboard 10 in accordance with the invention is shown. The lamp assembly comprises a plurality of units each comprising an elongated seat 12 having a section of U, the seat 12 including a lengthwise slot 16 and two lengthwise grooves 18 at both side walls wherein the seat 12 is secured to the billboard 10 by means of a fastener (e.g., screw) 20; and a substantially parallelepiped positioning member 14 comprising two lengthwise side flanges 32 snuggly fitted in the grooves 18 by sliding for coupling the positioning member 14 and the seat 12 together, two blades 26 at a forward side, two slits 28 at a rear side, and a socket 22 for threaded coupling to a lamp 24. As shown in FIG. 3, in one unit the blades 26 and slits 28 are electrically coupled together by a wire 30, and contacts in the socket 22 are electrically coupled to the wire. Also, the blades 26 are adapted to insert into the slits 28 of a forward, adjacent unit and the slits 28 are adapted to receive the inserted blades 26 of a rear, adjacent unit. In such a manner, it is possible of electrically coupling all lamps 24 together.

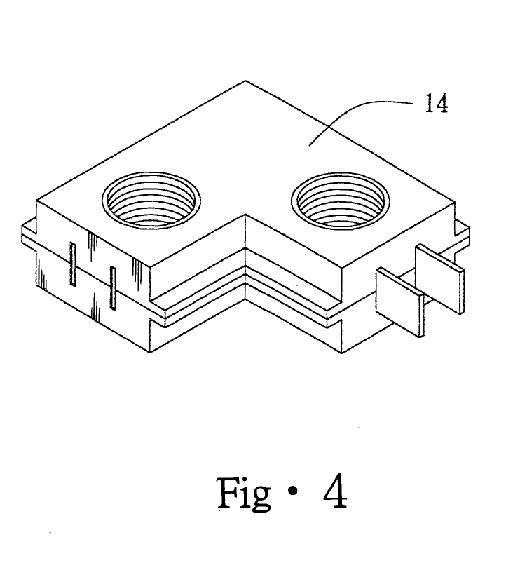

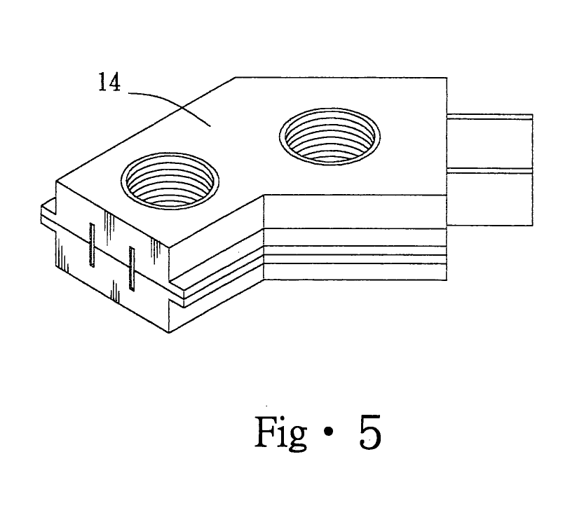

Referring to FIG. 4, in another configuration the unit comprises two sockets and the unit has a shape of L. Also, referring to FIG. 5, in still another configuration the unit comprises two sections each having a socket wherein one section is at an angle about 45 degrees with respect to the other section.

While the invention herein disclosed has been described by means of specific embodiments, numerous modifications and variations could be made thereto by those skilled in the art without departing from the scope and spirit of the invention set forth in the claims.

1. A lamp assembly mountable on a billboard, the lamp assembly including a plurality of units each comprising:
an elongated seat having a section of U, the seat including a lengthwise slot and two lengthwise grooves at both side walls wherein the seat is threadedly secured to the billboard; and
a substantially parallelepiped positioning member including two lengthwise side flanges snugly fitted in the grooves for coupling the positioning member and the seat together, two blades at a forward side, two slits at a rear side, and a lamp threaded coupled thereon,
wherein the blades and the slits of one unit are electrically coupled together, the lamp is electrically coupled to both the blades and the slits, the blades of one unit are adapted to insert into the slits of a second adjacent unit, and the slits of one unit are adapted to receive the blades of a third adjacent unit.

2. The lamp assembly of claim 1, wherein two units are formed as a unit member having a shape of L.

3. The lamp assembly of claim 1, wherein two units are formed as a bent unit member with one unit being disposed about 45 degrees with respect to the other unit.
